(19) United States
(12) Patent Application Publication
(10) Pub. No.: US 2026/0034489 A1
(43) Pub. Date: Feb. 5, 2026

(54) MODULAR AIR FILTER ASSEMBLY

(71) Applicant: Caterpillar Inc., Peoria, IL (US)

(72) Inventor: Timothy S. FINN, Morton, IL (US)

(73) Assignee: Caterpillar Inc., Peoria, IL (US)

(21) Appl. No.: 18/792,974

(22) Filed: Aug. 2, 2024

(51) Int. Cl. B01D 46/00; B01D 46/24; F02M 35/02

(52) U.S. Cl. CPC B01D 46/0043; B01D 46/0004; B01D 46/0013; B01D 46/24; F02M 35/0202; B01D 2279/60

(57) ABSTRACT

Modular air filter assemblies having a configurable inlet, a configurable outlet, and configurable mounting assembly are described herein. The modular filter assembly includes a tube, an aperture extending through a wall of the tube, an end cap at a first end of the tube, an outlet cap at a second end of the tube, and an inlet cap. The tube extends along a central axis from a first end to a second end and is configured to receive a filter. The inlet cap is configured to be fastened to the aperture in a first configuration and a second configuration, different from the first configuration. The inlet is in communication with the aperture in each of the first configuration and the second configuration.

### TECHNICAL FIELD

The present disclosure relates generally to an air filter assembly, and more particularly, to a modular air filter assembly having a configurable inlet, a configurable outlet, and configurable mounting assembly.

### BACKGROUND

Machines used in the farming, construction, mining, power generation, and other like industries commonly include a frame that supports an internal combustion engine, a work tool movably connected to the frame, and at least one hydraulic cylinder connected between the frame and the work tool and driven by the engine. Such machines typically operate in harsh environments characterized by large amounts of airborne dust, dirt, and debris. In such environments, it is desirable to remove such debris from the air before directing the air to the engine. To assist with this process, machines typically include an intake air filter assembly or other like air cleaner configured to remove airborne debris upstream of the engine.

One drawback of air filter assemblies, however, is that they may often be designed and assembled to fit within an engine bay of a particular machine model. Further, components of air filter assemblies may be fixed or molded together preventing modification to an air filter assembly designed for a machine model to permit said air filter assembly to be used in another, different machine. Moreover, fixed or molded components may limit a user's ability to repair the air filter assembly and may require replacement of the entire assembly instead of replacement of a component of the assembly.

U.S. Pat. No. 11,478,741, (“the '741 patent”), discloses an air cleaner assembly for cleaning engine air intake for an internal combustion engage. The air cleaner assembly of the '741 patent includes a housing, an outlet integral with the housing, an inlet fastenable to an end of the housing at two or more radial orientations, a dust ejector tube extending from the housing, and supports extending from the housing. While the inlet is fastenable at two or more orientations, the rotation of airflow within the housing cannot be changed (clockwise or counter-clockwise air flow within the housing). Moreover, the outlet, supports, and dust ejector tube are integral the housing. Thus usage of the air cleaner assembly of the '741 patent is limited to a subpopulation of machines that can accommodate the fixed positioning of the supports, the outlet, and the dust ejector tube and do not require a different rotation of airflow.

The present disclosure may solve one or more of the problems set forth above and/or other problems in the art. The scope of the current disclosure, however, is defined by the attached claims, and not by the ability to solve any specific problem.

### SUMMARY

Each of the aspects disclosed herein may include one or more features described in connection with any of the other disclosed aspects.

The present disclosure includes a modular filter assembly comprising a tube, an aperture extending through a wall of the tube, an end cap at a first end of the tube, an outlet cap at a second end of the tube, and an inlet cap. The tube may extend along a central axis from a first end to a second end and configured to receive a filter. The inlet cap may include an inlet extending radially outward from the central axis. The inlet cap may be configured to be fastened to the aperture in a first configuration and a second configuration, different from the first configuration. The inlet may be in communication with the aperture in each of the first configuration and the second configuration.

In some examples, the modular filter assembly may include any and all of the following features. In the first configuration, the inlet may be positioned such that gas received within the tube circulated in a counter-clockwise direction relative to the central axis. In the second configuration, the inlet may be positioned such that gas received within the tube circulates in a clockwise direction relative to the central axis. The outlet cap may be fastenable to the tube at a plurality of radial orientations relative to the central axis. The outlet cap may be fastenable to a plurality of fastener holes positioned at the second end of the tube. The plurality of fastener holes may be evenly arrange along an inner circumference of the tube. The first end of the tube may include a flange extending radially outward from the central axis. The end cap may be fastenable to the flange. The inlet cap may include a curved surface and the wall of the tube may include a curved surface. A radius of an arc of the curved surface of the inlet cap may be approximately less than or equal to a radius of an arc of the curved surface of the tube. The curved surface of the inlet cap may be configured to at least partially cover the aperture of the tube.

In some exemplary embodiments, the modular filter assembly may include any and all of the following features. For example, the modular filter assembly may further comprise two or more brackets. The two or more brackets may radially surround an exterior surface of the tube. Each of the two or more brackets may include a curved surface. A radius of an arc of the curved surface of the brackets may be approximately greater than or equal to a radius of an arc of the curved surface of the tube. One of the two or more brackets may be an inlet bracket. The inlet bracket may include an opening sized and shaped to receive the inlet of the inlet cap. The curved surface of the inlet cap may be fastened to an interior surface of the tube. Each of the two or more brackets may include one or more fastener holes at a first side and one or more fastener holes at a second side, opposite to the side.

The disclosure further includes another modular filter assembly comprising: a tube, an end cap at a first end of the tube, an outlet at the second end of the tube, and an inlet. The tube may extend along a central axis between a first end and a second end. The tube may include an aperture extending through a surface of the tube. The inlet may extend radially outward from the surface of the tube along an axis orthogonal to the central axis. The inlet may be configured to be fastened to the aperture in a first configuration and a second configuration, different than the first configuration. The inlet may be in communication with the aperture in each of the first configuration and the second configuration. The outlet may be fastenable to the second end of the tube at a plurality of radial orientations relative to the central axis.

In some examples, the modular filter assembly may include any and all of the following features. For example, in the first configuration, the inlet may be positioned such that gas received within the tube circulates in a counter-clockwise direction relative to the central axis. In the second configuration, the inlet may be positioned such that gas received within the tube circulates in the clockwise direction relative to the central axis. The end cap may be fastenable to the tube at a plurality of radial orientations relative to the central axis. The outlet may include one or more bosses extending radially outward from the central axis configured to receive one or more sensors.

The disclosure includes another modular filter assembly comprising a tube, an aperture through a wall of the tube, an end cap, an outlet, and an inlet. The tube may define a chamber and extend along a central axis. The inlet may extend radially outward from the central axis. The inlet may be in communication with the chamber via the aperture. The inlet may be configured to be fastened to the aperture in a first configuration and a second configuration, different from the first configuration. In the first configuration, the inlet may be positioned such that gas received within the tube circulates in a counter-clockwise direction relative to the central axis. In the second configuration, the inlet may be positioned such that gas received within the tube circulated in a clockwise direction relative to the central axis. The outlet may be fastenable to the tube at a plurality of radial orientations relative to the central axis. The end cap may be fastenable to the tube at a plurality of radial orientations relative to the central axis.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a side view of an exemplary machine including an exemplary modular filter assembly, according to aspects of the disclosure.

FIG. 2A depicts a perspective view of the modular filter assembly in a first orientation and having an inlet cap of the modular filter assembly in a first configuration.

FIG. 2B depicts an exploded view of the modular filter assembly of FIG. 2A.

FIG. 3 depicts a bracket system of the modular filter assembly.

FIG. 4A depicts a portion of the modular filter assembly according to some aspects of this disclosure.

FIG. 4B depicts a portion of modular filter assembly according to some aspects of this disclosure.

FIG. 5 depicts a first bracket of the modular filter assembly.

FIG. 6 depicts a second bracket, different from the first bracket, of the modular filter assembly.

FIG. 7 depicts an exploded view of a tube and the inlet cap of the modular filter assembly in a second configuration.

FIG. 8 depicts the tube and an outlet cap of modular filter assembly.

FIG. 9 depicts the modular filter assembly in a second orientation.

FIG. 10 depicts the modular filter assembly in a third orientation.

FIGS. 11-12 depict the modular filter assembly in a fourth orientation with an alternative inlet cap.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of 10% in the stated value.

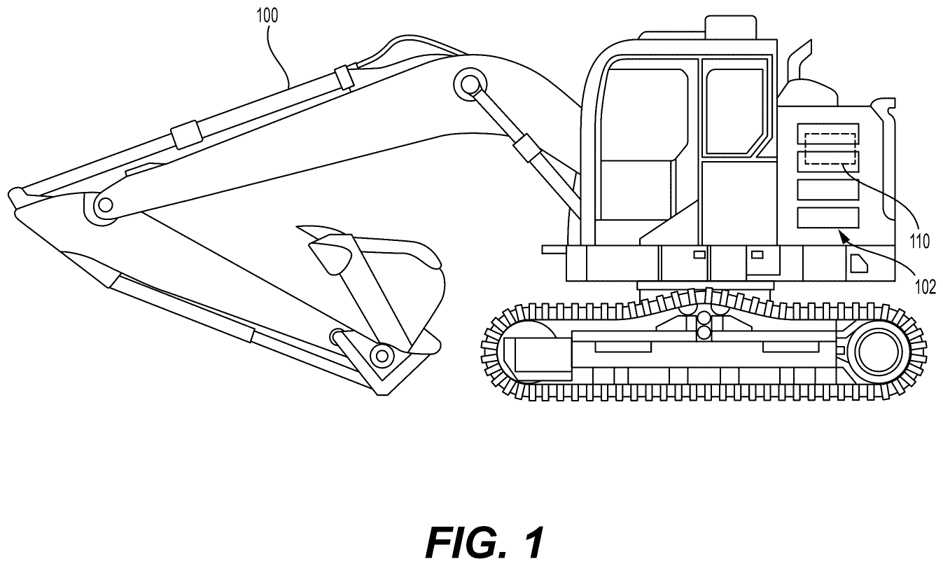

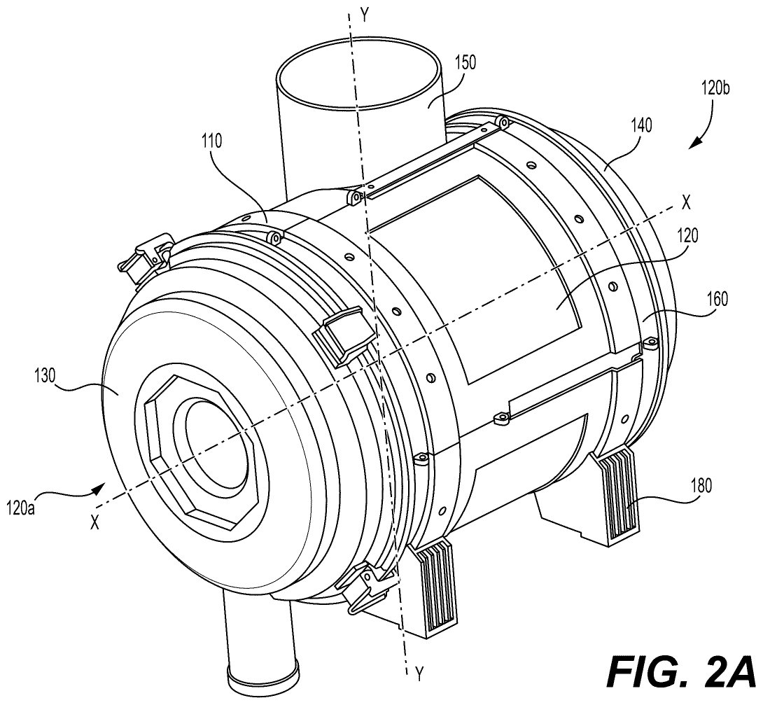

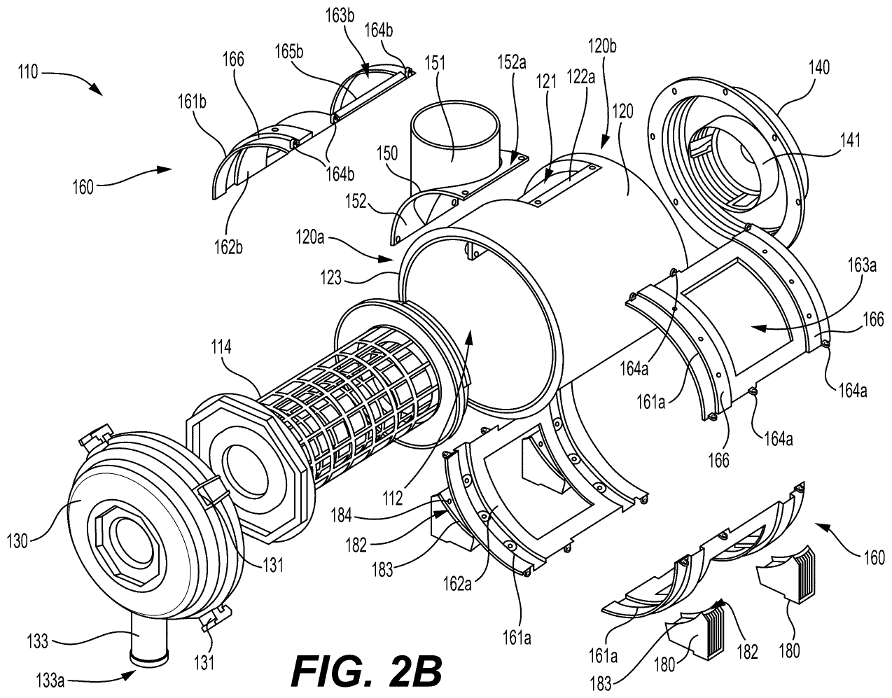

FIG. 1 depicts an exemplary machine (“machine”) 100 configured to be used in the farming, construction, mining, power generation, and other like industries. Machine 100 may include an engine bay 102 with an engine (e.g., a combustion engine) therein. Machine 100 may further include a modular air filter assembly 110 in communication with the engine such that outflowing fluid (e.g., gases, air) from modular air filter assembly 110 enters the engine. Modular air filter assembly 110 may include a filter 114 (as shown in FIG. 2B) and be configured to remove debris from inflowing air of modular air filter assembly 110 such that outflowing air entering the engine is substantially free of debris that may damage or decrease the efficiency of the engine.

As shown at least in FIGS. 2A-2B, modular air filter assembly 110 (hereinafter “assembly 110”) includes a first orientation. Assembly 110 may define a central axis X (shown in FIG. 2A). Assembly 110 may include a filter chamber 112 (FIG. 2B) configured to contain filter 114 therein. A longitudinal axis of filter 114 may be coaxial or approximately coaxial (e.g., parallel) with central axis X. Air within filter chamber 112 may rotate and/or circulate around filter 114 during use.

Assembly 110 may include a tube 120. Tube 120 may have a first end 120a and a second end 120b, opposite to first end 120a. Tube 120 may include a cylindrical shape; however, this is merely exemplary and tube 120 may include any shape. Tube 120 may extend along central axis X. At least a portion of filter chamber 112 may be defined by tube 120. As shown in FIGS. 2B, 7, and 8, tube 120 may define an aperture 121 through a wall of tube 120. For example, aperture 121 may be defined through a curved wall or curved surface of tube 120. Aperture 121 may include a rectangular shape; however this is merely exemplary and aperture 121 may include any shape. Aperture 121 is in fluid communication with filter chamber 112, Tube 120 may include a first mounting plate 122a at first side or end of aperture 121 and a second mounting plate 122b at a second side or end of aperture 121, opposite to the first side. Relative to central axis X, aperture 121 of tube 120 may be positioned at any radial orientation (e.g., radial position) (e.g., tube 120 may be rotated along central axis X so as to adjust aperture 121). Aperture 121 may extend through the wall (e.g., the curved side wall) of tube 120 in a direction that is orthogonal or perpendicular to central axis X.

Assembly 110 may include an end cap 130 at first end 120a, Tube 120 may include a flange 123 and an opening at first end 120a. End cap 130 may be sized and shaped to fully cover or overlap, eclipse, or otherwise enclose the opening of tube 120 at first end 120a. For example, when tube 120 includes a cylindrical shape (e.g., the tube has a circular cross-sectional shape), end cap 130 may include a corresponding circular shape with sufficient area to fully cover the opening of tube 120 at first end 120a. Flange 123 may extend radially outward from an exterior surface (e.g., the curved side wall) of tube 120 relative to central axis X. End cap 130 may include one or more fasteners 131 releasably attachable (e.g., fastenable) to flange 123 at a plurality of radial orientations (e.g., radial positions). For example, as shown in the figures, one or more fasteners 131 may include four fasteners 131 equidistantly positioned about an exterior (e.g., about a circumference or perimeter) of end cap 130. However, the disclosure is not so limited, Rather, one, two, three, five, or more fasteners may be positioned about the exterior of end cap 130, equidistantly or non-equidistantly. One or more fasteners 131 may include a latch; however, this is merely to serve as an example and one or more fasteners 131 may include any type and number of fasteners sufficient to fasten end cap 130 to flange 123 and/or the opening of tube 120 at first end 120a. When fastened to tube 120, end cap 130 may form an air tight seal preventing air from exiting filter chamber 112 via the opening of tube 120 at first end 120a.

As shown at least in FIGS. 2A-2B, end cap 130 may include a drop tube 133. Drop tube 133 may be in fluid communication with filter chamber 112 such that debris within filter chamber 112, not captured by filter 114, may exit via drop tube 133. As discussed above, end cap 130 may be releasably attached to flange 123 at a plurality of radial orientations. End cap 130 may be radially orientated relative to tube 120 such that an outlet 133a of drop tube 133 is pointed, approximately, toward the ground (e.g., a horizon or a 6 o'clock position). As debris enters drop tube 133, gravitational force may pull debris toward outlet 133a. According to some aspects, end cap 130 may be radially orientated relative to tube 120 such that outlet 133a of drop tube 133 faces any direction (e.g., 1 o'clock, 2 o'clock, 3 o'clock, . . . , 12 o'clock, etc.). In some examples, end cap 130 may be radially orientated relative to tube 120 such that outlet 133a of drop tube 133 faces 6 o'clock+/−30 degrees.

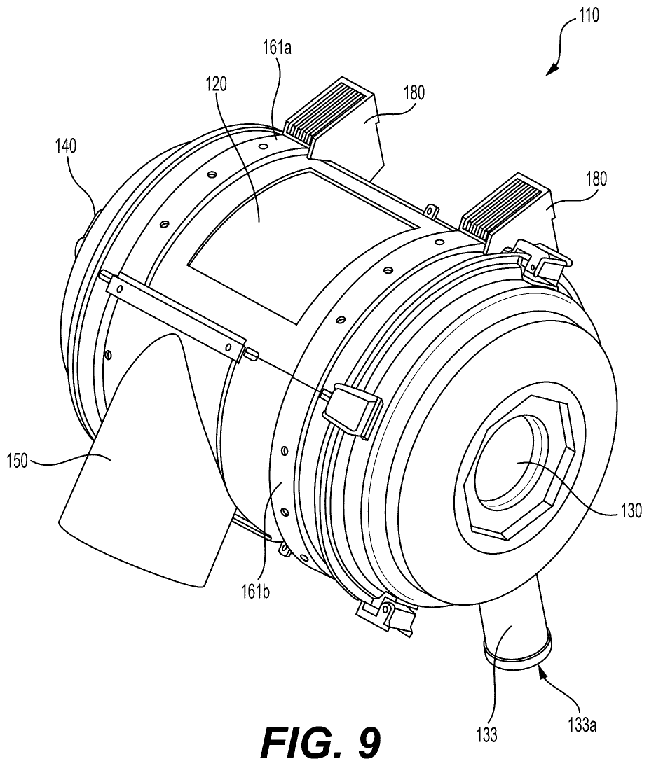

As shown at least in FIGS. 2A-2B, and 8, assembly 110 may include an outlet cap 140 at second end 120b. Outlet cap 140 may include an outlet 141, at least a portion of outlet 141 extending away from tube 120. Further, outlet 141 may extend along central axis X and may be coaxial with tube 120. Outlet cap 140 may include a cylindrical protrusion/boss 142 extending radially outward from an exterior surface of outlet 141. Boss 142 may define a channel or lumen in fluid communication with outlet 141. The lumen of boss 142 may be configured to receive one or more sensors therein. Outlet cap 140 may be sized and shaped to fully cover or overlap, eclipse, or otherwise enclose the opening of tube 120 at second end 120b. For example, when tube 120 includes a cylindrical shape (e.g., the tube has a circular cross-sectional shape), outlet cap 140 may include a corresponding circular shape with sufficient area to fully cover the opening of tube 120 at second end 120b. According to some aspects of the disclosure, outlet cap 140 may include one or more bosses 142. Each of one or more bosses 142, and lumens thereof, may include dimensions corresponding to a specific size, shape, or model of sensor, and may include threading within the lumen of one or more bosses 142.

As shown in FIG. 8, second end 120b of tube 120 may include a plurality of protrusions 124 extending radially inward relative to central axis X from an interior surface of tube 120. A surface at second end 120b of each of plurality of protrusions 124 may define a fastener hole 124a extending from the surface toward first end 120a. Plurality of protrusions 124 may be equidistantly positioned about an interior (e.g., about an inner circumference or perimeter) of tube 120 at second end 120b. However, the disclosure is not so limited. Rather, plurality of protrusions 124 may include two, four, eight or more protrusions 124 positioned at second end 120b of tube 120, equidistantly or non-equidistantly. As shown in FIG. 8, as an example, plurality of protrusions 124 may include eight protrusions.

Still referring to FIG. 8, outlet cap 140 may include a flange 143. A plurality of fastener holes 144 may be defined through flange 143. Outlet cap 140 may include any number of fastener holes 144 sufficient to secure outlet cap 140 to tube 120, For example, outlet cap 140 may include a number of fastener holes equal to a number of fastener holes 124a, For example, flange 143 may include eight fastener holes 144 corresponding to eight fastener holes 124a. Plurality of fastener holes 144 may be evenly spaced along a circumference of a circle radially inward of an outer edge of flange 143. Plurality of fastener holes 144 may be arranged about flange 143 to be alignable—and fastenable—with holes 124a of protrusions 124 at a plurality of radial orientations (e.g., radial positions). Outlet cap 140 may be fastened to second end 120b by aligning fastener holes 144 with fastener holes 124a, inserting fasteners (e.g., a screw) through aligned holes 144, 124a, and tightening the fasteners. When fastened to tube 120, outlet cap 140 may form an air tight seal preventing air from exiting filter chamber 112 via the opening of tube 120 at second end 120b.

As discussed above, outlet cap 140 may be alignable and fastenable to second end 120b of tube 120 at a plurality of radial orientations. For example, when plurality of protrusions 124 includes eight protrusions 124, outlet cap 140 may be fastened to second end 120b at eight radial orientations. It other words, when viewed from the viewing angle of FIG. 8, a central axis of boss 142 may be aligned at 12 o'clock (as shown in FIG. 8) and aligned in 45 degree increments in the clockwise or counter-clockwise directions. According to some aspects of the disclosure, holes 124a, 144 may be omitted and outlet cap 140 may be fastened to second end 120b similar to how end cap 130 is fastened to flange 123 at first end 120a or other types fasteners may be used to fasten end cap 140 to second end 120b.

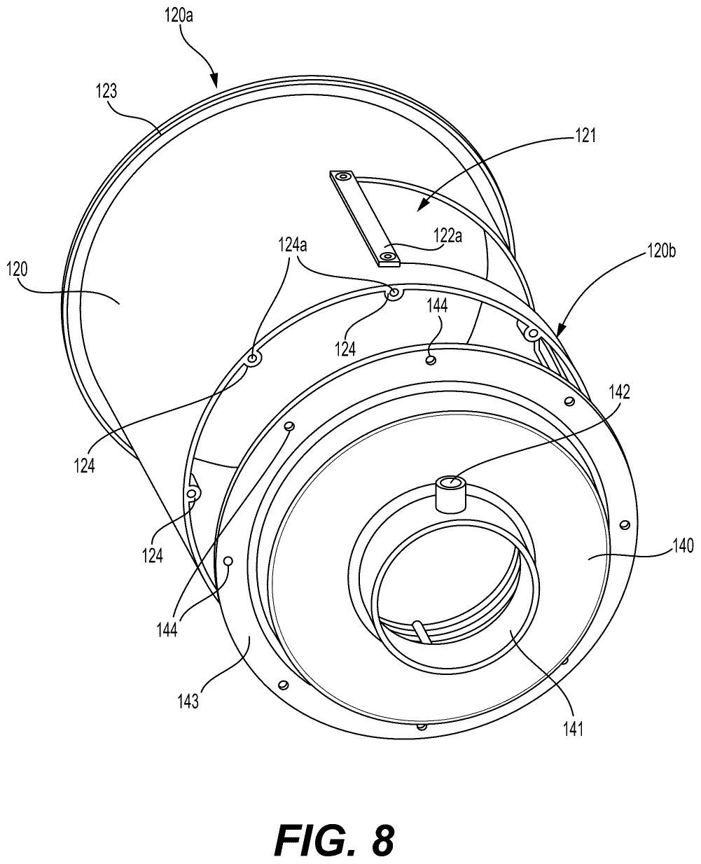

Referring to FIGS. 2B and 7, assembly 110 may include an inlet cap 150 configured to be fastenable along a perimeter of aperture 121 in a first configuration and a second configuration, different from the first configuration. Inlet cap 150 may include an inlet 151 and a curved surface 152. Curved surface 152 may extend outward from an end of inlet 151 and may define an opening in communication with a lumen of inlet 151. Inlet 151 may be in fluid communication with aperture 121 and filter chamber 112 such that inflowing air from inlet 151 enters filter chamber 112. A perimeter of aperture 121 may be fully contained, covered, or enclosed by a perimeter of curved surface 152. In other words, one or more dimensions of the perimeter of curved surface 152 may be greater than one or more dimensions of the perimeter of aperture 121. Inlet cap 150 may be configured to at least partially cover aperture 121. Said differently, a perimeter and shape of curved surface 152 may be sized and shaped to correspond to a perimeter and shape of aperture 121 and tube 120 such that air flowing in through inlet 151 may be communicated to filter chamber 112. In some examples, inlet cap 150 (e.g., curved surface 152) may be fastened to an interior surface of tube 120 and curved surface 152 may be disposed within tube 120. Inlet 151 may extend through aperture 121, For example, a radius of an arc of curved surface 152 may be approximately equal to or less than a radius of an arc of an interior curved surface (e.g., side wall) of tube 120. A portion of an exterior surface of curved surface 152 may be flush or approximately flush with a portion of the interior curved surface of tube 120. A first end of 152a of curved surface 152 may be aligned with one of first mounting plate 122a and second mounting plate 122b and a second end 152b of curved surface 152 may be aligned with the other of first mounting plate 122a and second mounting plate 122b.

In other examples, the radius of the arc of curved surface 152 may be approximately greater than or equal to a radius of an arc of an exterior curved surface (e.g., side wall) of tube 120 and curved surface 152 may be disposed on the exterior curved surface of tube 120. For example, a portion of an interior surface of curved surface 152 may be flush or approximately flush with a portion of the exterior curved surface of tube 120. First end 152a of curved surface 152 may be sized and shaped to at least partially cover one of first mounting plate 122a and second mounting plate 122b and second end 152b of curved surface 152 may be sized and shaped to at least partially cover the other of first mounting plate 122a and second mounting plate 122b.

As discussed above, inlet cap 150 may be fastenable to aperture 121 in the first configuration (e.g., FIGS. 2A and 2B) and the second configuration (e.g., FIG. 7). As shown in FIG. 2A, inlet 151 may extend along a central longitudinal axis Y of inlet 151 and may be disposed at an angle relative to curved surface 152 (e.g., the central longitudinal axis Y extending through inlet 151 may be oriented at a non-normal (e.g., non-perpendicular) angle relative to a plane tangent to curved surface 152) so as to direct air entering through inlet 151 in a desired direction (e.g., clock-wise or counter-clock-wise) about central axis X. Further, the central longitudinal axis Y may be orthogonal to and spaced away from (e.g., nonintersecting with) central axis X. In the first configuration, shown in FIGS. 2A and 2B, first end 152a of curved surface 152 may cover mounting plate 122a and second end 152b may cover mounting plate 122b. In the first configuration, when viewed from the viewing angle of FIG. 2A (e.g., along central axis X in the direction from first end 120a toward second end 120b) due to the angular displacement of inlet 151 relative to curved surface 152, inflowing air from inlet 151 may rotate and/or circulate around filter 114 within filter chamber 112 in a counter-clockwise direction. As an example, inlet cap 150 is positioned in the first configuration in the orientations of assembly 110 shown in FIGS. 2A and 2B. Compared to the first configuration, in the second configuration, inlet cap 150 may be rotated approximately 180 degrees (e.g., about the central longitudinal axis Y of inlet 151). In the second configuration, as shown in FIG. 7, first end 152a may be aligned with mounting plate 122b and second end 152b may be aligned with mounting plate 122a. In the second configuration, when viewed from the viewing angle of FIG. 2A (e.g., along central axis X in the direction from first end 120a toward second end 120b), inflowing air from inlet 151, may rotate around filter 114 within filter chamber 112 in a clockwise direction. According to aspects where curved surface 152 is exterior to tube 120, in the second configuration, first end 152a and second end 152b may be aligned with and cover respective mounting plates 122a, 122b.

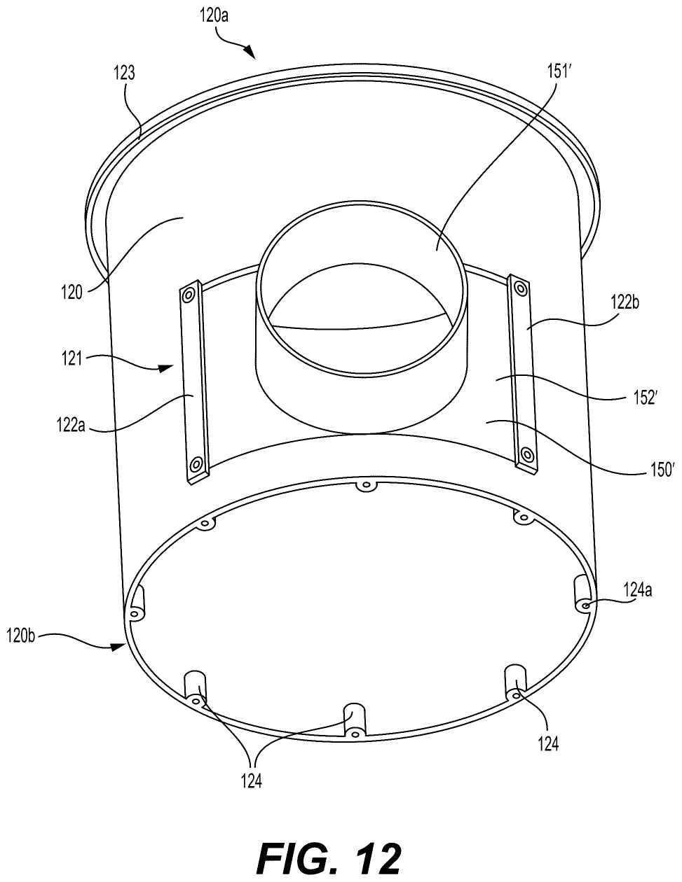

FIGS. 11 and 12 depict an alternate embodiment of inlet cap 150, labeled as inlet cap 150′. Inlet cap 150′ may be used in replacement of inlet cap 150. Inlet cap 150′ may include any of the features of inlet cap 150 and may differ as described below. Inlet cap 150′ may include a curved surface 152′. Curved surface 152′ may extend outward from an end of inlet 151′ and may define an opening in communication with a lumen of inlet 151′. Compared to inlet cap 150 and inlet 151, inlet 151′ may extend radially outward relative to central axis X from a midpoint of curved surface 152′. For example, inlet 151′ may extend along a central longitudinal axis Y′ and may extend perpendicular or transverse to central axis X and a longitudinal axis of filter 114. That is, inlet 151′ may be disposed at normal angle relative to curved surface 152′ (e.g., a central longitudinal axis extending through inlet 151′ may be perpendicular relative to a plane tangent to curved surface 152′). Further, inlet 151′ may extend along the central longitudinal axis Y′ that is orthogonal to and intersecting (e.g., perpendicular) with central axis X. As shown in FIG. 11, inflowing air through inlet 151′ may directly contact filter 114 disposed within filter chamber 112. In other words, inflow air may contact a surface of filter at an angle perpendicular to a plane tangent to a curved surface of filter 114. Compared to embodiments including inlet cap 150, inflowing air through inlet 151′ may not circulate in a clockwise or counter clockwise direction and instead inflowing air may contact filter 114 and flow toward outlet 141 and/or outlet 133a of drop tube 133. Drop tube 133 of end cap 130 is omitted from FIG. 11 to highlight features of inlet cap 150′. It should be understood that drop tube 133 may be generally oriented in the 6 o'clock position+/−30 degrees in the clockwise and counterclockwise directions. Including inlet cap 150′ may be used in embodiments of assembly 110 configured to be used in low-dust environments (e.g., aquatic environments, ventilated or filtered-air buildings, such as hospitals).

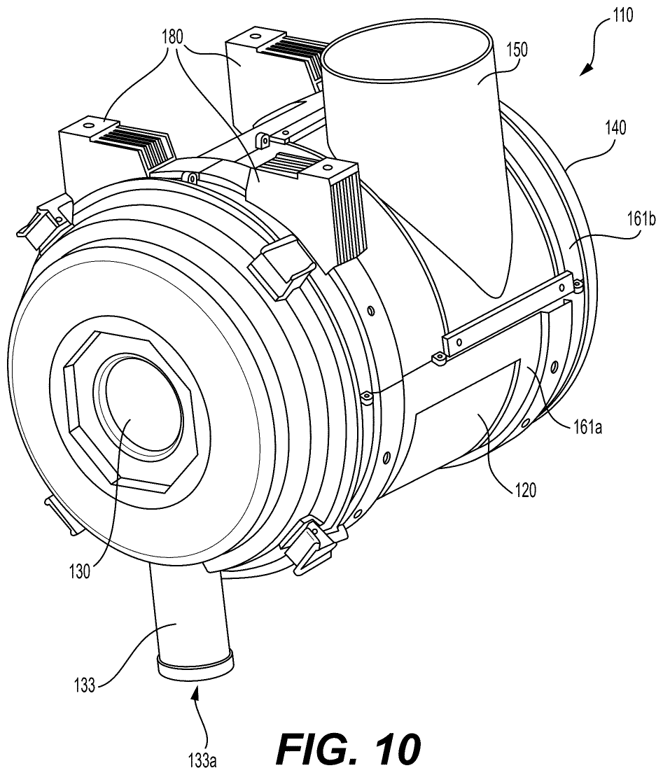

The radial orientation of aperture 121 relative to central axis X and the selected configuration of inlet cap 150 may permit assembly 110 to be used in a wide variety of conditions. For example, as shown in FIGS. 2A, 10, and 11, when aperture 121 is radially oriented and inlet 151 is positioned such that an opening (e.g., a radially outward opening relative to central axis X) of inlet 151 is pointed generally upward (e.g., generally in the direction from 6 o'clock to 12 o'clock), inlet 151 may be coupled to a precleaner (or other structure) exterior to engine bay 102 or exterior to a chassis of machine 100 and/or may be configured to receive inflowing air from an environment exterior to engine bay 102 or exterior to a chassis of machine 100. As shown in FIG. 9, when aperture 121 is radially oriented and inlet 151 is positioned such that the opening of inlet 151 is pointed generally downward (e.g., generally away from the 12 o'clock position), inlet 151 may be coupled to a precleaner (or other structure) within engine bay 102 and/or configured to receive inflowing air from within engine bay 102.

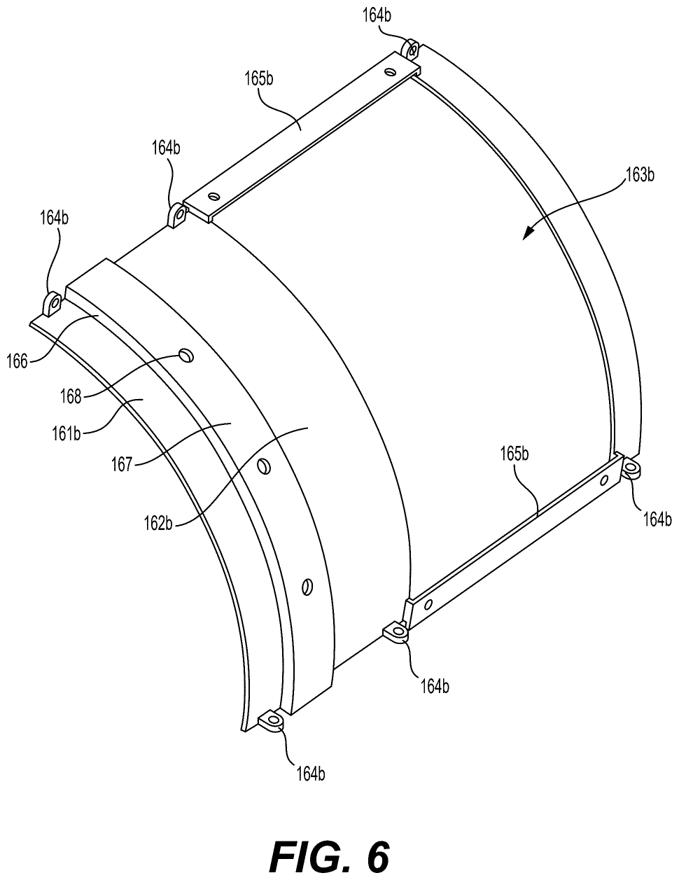

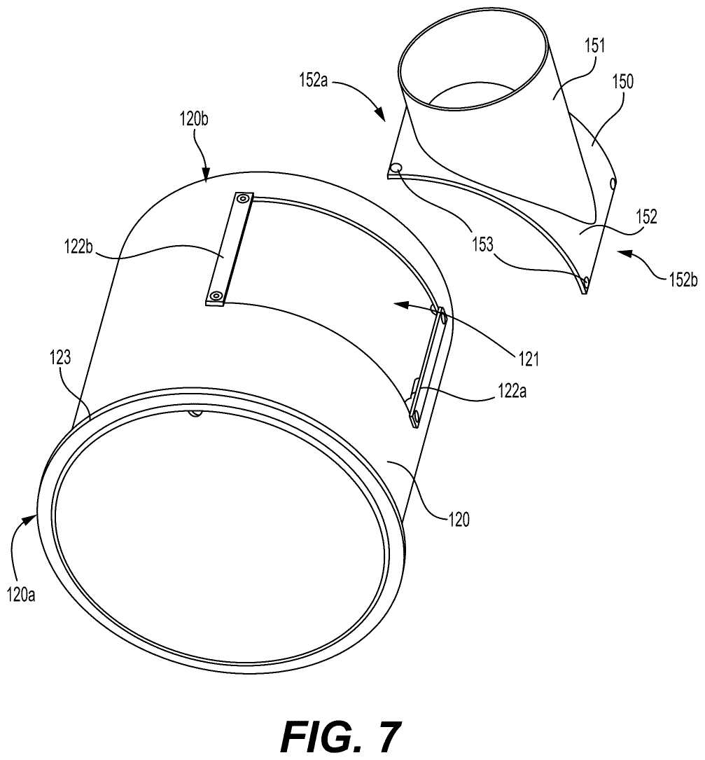

As shown in at least FIGS. 2A-4B, assembly 110 includes a modular mounting assembly 160 (hereinafter “mounting assembly 160”) having two or more brackets. In some examples, mounting assembly 160 may include four or more brackets. Mounting assembly 160 and/or assembly 110 may include two or more supports 180. Supports 180 may be fastenable to one or more of the two or more brackets. Mounting assembly 160 may include a first bracket 161a (see FIG. 5) and a second bracket 161b (see FIG. 6). For example, mounting assembly 160 may include three or more first brackets 161a and one or more second brackets 161b. Brackets 161a, 161b may partially or fully surround (e.g., radially surround relative to central axis X) tube 120. Interior surfaces of brackets 161a, 161b may be flush or approximately flush with the exterior surface of tube 120. In some examples, curved surface 152 of inlet cap 150 may be fastened to the interior surface of tube 120 about aperture 121. According to other aspects of the disclosure, curved surface 152 of inlet cap 150 may be fastened between the exterior surface of tube 120 and an interior surface of one of brackets 161a, 161b.

As shown in FIG. 5, first bracket 161a may include a curved surface 162a. An arc defined by curved surface 162a may include an approximately 90 degree angle. A radius of the arc defined by curved surface 162a may be approximately greater than or equal to the radius of tube 120. First bracket 161a may define an aperture 163a through curved surface 162a. Aperture 163a may reduce materials costs of manufacturing first bracket 161a. According to some aspects, aperture 163a may be omitted from one or more of first brackets 161a.

As shown in FIG. 6, second bracket 161b (also referred to herein as an “inlet bracket”) may include a curved surface 162b. An arc defined by curved surface 162b may include an approximately 90 degree angle. A radius of the arc defined by curved surface 162b may be approximately greater than or equal to the radius of tube 120. Second bracket 161b may define an aperture 163b through curved surface 162b. Aperture 163b may be sized and shaped to receive inlet 151 therein, but a perimeter of aperture 163b may be sized smaller than a perimeter of curves surface 152 such that curved surface 152 does not pass through aperture 163b. Second bracket 161b may include a first mounting plate 165b at a first end of aperture 163b and a second mounting plate 165b at a second end of aperture 163b.

As shown in FIGS. 5 and 6, first bracket(s) 161a and second bracket(s) 161b may each include one or more radially outward extending protrusions. For example, first bracket 161a may include one or more protrusions 164a (e.g., one or more eyelets) at a first end of first bracket 161a and one or more protrusions 164a at a second end of first bracket 161a, opposite the first end of first bracket 161a. Second bracket 161b may include one or more protrusions 164b (e.g., one or more eyelets) at a first end of second bracket 161b and one or more protrusions 164b at a second end of second bracket 161b, opposite to the first end of second bracket 161b. One or more protrusions 164a, 164b may extend from an exterior surface of respective brackets 161a, 161b. A length between the first end and the second end of first bracket 161a and a length between the first end and the second end of second bracket 161b may extend perpendicular or transverse to central axis X. Protrusions 164a, 164b may each define a fastener hole extending from first side of protrusions 164a, 164b, respectively, to a second side of protrusions 164a, 164b. For example, the first side of protrusions 164a, 164b may be a side nearer to the first end of brackets 161a, 161b and the second side of protrusions 164a, 164b may be a side nearer to the second end of brackets 161a, 161b.

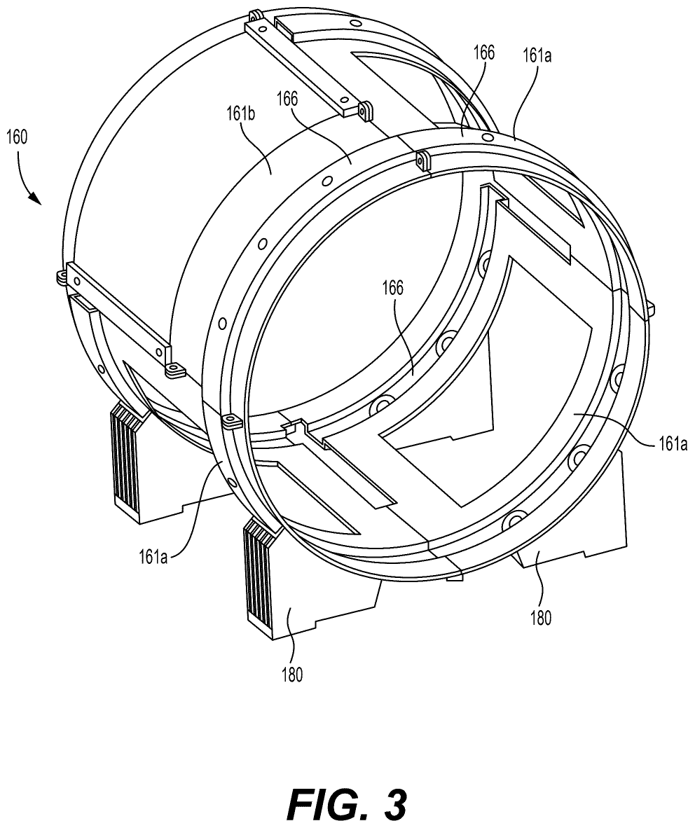

As shown in FIG. 3, first bracket(s) 161a and second bracket(s) 161b may be fastenable to one another at protrusions 164a, 164b to fully or partially surround tube 120. For example, each of protrusions 164b may be aligned with and fastened to one of protrusions 164a or one of protrusions 164b. It should be understood that a fastener (e.g., a screw) is insertable into each alignment of fastener holes of protrusions 164a, 164b. When first bracket(s) 161a and second bracket(s) 161b are fastened to one another, curved surfaces 162a, 162b may define an opening and/or space sized and shaped to receive or contain tube 120 therein. For example, as shown in FIG. 3, mounting assembly 160 includes three first brackets 161a and one second bracket 161b. Three first brackets 161a and one second brackets 161b may be fastened together so that curve surfaces 162a, 162b (FIG. 2B) may define a circular opening configured to receive tube 120 and so that aperture 121 of tube 120 is aligned with aperture 163b of second bracket 161b. Mounting assembly 160 may be fastened to tube 120 at a plurality of radial orientations (e.g, radial positions) relative to central axis X.

Referring to FIGS. 5 and 6, curved surfaces 162a, 162b may each define one or more channels 166. For example, first bracket 161a may include two or more channels 166 and second bracket 161b may include one or more channels 166. Each channel 166 may extend in a circumferential direction around central axis X and may extend from the first end to the second end of respective brackets 161a, 161b. In other words, each channel 166 may extend between respective protrusions 164a, 164b. Channels 166 of first bracket 161a may be positioned such that one of channels 166 is nearer to first end 120a and the other of channels 166 is nearer second end 120b. Aperture 163a of first bracket 161a may be positioned between two channels 166. Channel 166 of second bracket 161b may be positioned such that channel 166 is nearer to first end 120a than aperture 163b.

Each channel 166 (e.g., channels 166 of first bracket 161a and second bracket 161b) may define a channel bed 167. Channel bed 167 may protrude radially outward from respective curved surface 162a, 162b, and may be a radially outwardmost surface of channel 166. One or more fastener holes 168 may be defined through channel bed 167 along a longitudinal length of channel 166. In some example, one or more fastener holes 168 may include two or more fastener holes 168. As shown in FIGS. 5 and 6, one or more fastener holes 168 may include three fastener holes 168. One or more fastener holes 168 are equidistantly positioned about a length of channel bed 167. For example, an angle of an arc between two adjacent fastener holes 168 may include an angle of approximately 22.5 degrees.

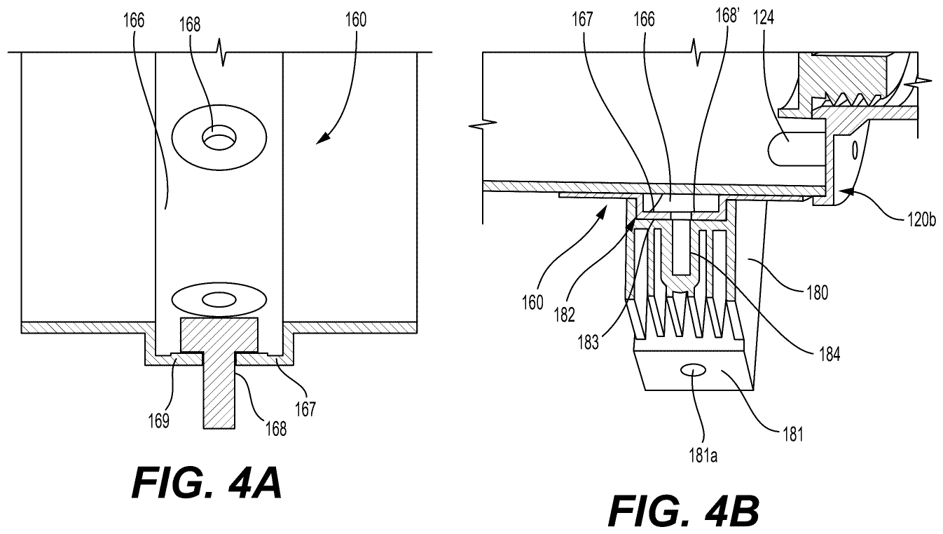

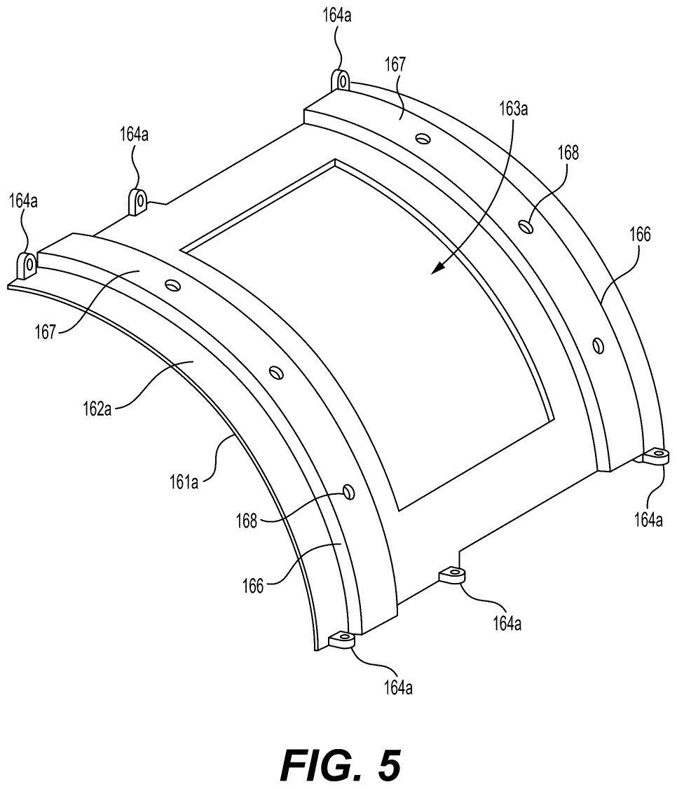

According to some aspects of this disclosure, as shown in FIG. 4A, channel bed 167 may include a protrusion 169 (e.g., an annular protrusion) extending radially inward relative to central axis X. Protrusion 169 may extend along a perimeter of each fastener hole 168. A radially inward-facing, planar surface of protrusion 169 may be configured to support a portion of a fastener. For example, the planar surface of protrusion 169 may support a head of a screw while a threaded portion of the screw is received through fastener hole 168 and into one of supports 180.

According to other aspects of this disclosure, as shown in FIG. 4B, fastener hole 168 may be replaced with a fastener hole 168′ which may be sized and shaped such that an entire fastener is insertable through fastener hole 168′. For example, fastener holes 168′ may be sized and shaped so that the head and threaded portion of the screw may be extended through each of fastener holes 168′. The head of the screw may be supported by a surface of one of supports 180 and the threaded portion of the screw may be received within the same support 180. An annular wall of fastener holes 168′ may limit movement and/or rotation of fasteners received within fastener holes 168′. For example, the head of the screw may contact the annular wall of one of fastener holes 168′ to limit movement and/or rotation of the screw.

As depicted in FIGS. 2A-4B, mounting assembly 160 and/or assembly 110 includes two or more mounting feet/supports 180. The two or more supports 180 may be fastenable to an exterior surface of brackets 161a, 161b in a plurality of radial orientations (e.g., radial positions) relative to central axis X and a plurality of positions along central axis X. For example, as shown in FIG. 2A-2B, assembly 110 may include four supports 180 with two of the four supports positioned along one or more of channels 166 adjacent to first end 120a and two of the four supports positioned along one or more channels 166 adjacent to second end 120b. Supports 180 may be fastened to an exterior surface of one or more of channels 166. Each support 180 may define a planar surface 181 configured to rest on a ground, surface, or horizon. For example, planar surface 181 of each support 180 may rest on a shelf or platform within engine bay 102. Supports 180 may be fastened to one or more of brackets 161a, 161b such that planar surfaces 181 of supports 180 are coplanar or approximately coplanar. According to some aspects, a fastener hole 181a may be defined through planar surface 181 so that supports 180 may be fastened to another structure in addition to be fastened to brackets 161a, 161b.

Each support 180 may include a channel 182. Channel 182 may include a curve with a radius of an arc of the curve being greater than or equal to the radius of the arc of respective curved surfaces 162a, 162b. Channel 182 may include a channel bed 183. Channel bed 183 may be a radially outwardmost surface of channel 182. Channel 182 may be sized and shaped to receive a portion of one or more of channels 166 therein. An exterior surface of channel bed 167 may be flush with channel bed 183.

As shown in FIGS. 2B and 4A-4B, supports 180 may each include one or more fastener holes 184 corresponding to fastener holes 168, 168′ of brackets 161a, 161b, respectively. For example, one or more fastener holes 184 may include two fastener holes 184 so that each support 180 may be secured to one or more of brackets 161a, 161b at two positions to prevent rotation of support 180. Fastener holes 184 may be defined through channel bed 183 and extend along a length of channel 182. Fastener holes 184 may include a threaded portion configured to receive a corresponding threaded portion of a fastener. As shown in FIG. 4A, a head portion of the fastener may be supported by protrusion 169 and the threaded portion is received with in fastener hole 184. As shown in FIG. 4B, the head portion of the fastener may be supported by channel bed 183 and the threaded portion of the fastener is received within fastener hole 184. To fasten one support 180 to first bracket 161a and/or second bracket 161b, a fastener may be inserted through one of fastener holes 168, 168′ and one of fastener holes 184 and then tightened.

As shown in FIGS. 2A, 9, and 10, inlet cap 150 may be fastened to tube 120 about aperture 121 (e.g., inlet cap 150 may at least partially cover aperture 121). As discussed above, curved surface 152 of inlet cap 150 may be disposed within tube 120 and fastened to the interior surface of tube 120. Inlet cap 150 may include one or more fastener holes 153 (FIG. 7). For example, inlet cap 150 may include four fastener holes 153 with one hole 153 being defined through each corner of curved surface 152. Mounting plates 122a, 122b, 165b may each include a first longitudinal end (e.g., an end nearest to one of first end 120a and second end 120b) and a second longitudinal end (e.g., an end nearest to the other of first end 120a and second end 120b). Mounting plates 122a, 122b, 165b may each define a fastener hole at their respective first longitudinal end and second longitudinal end.

To fasten inlet cap 150 to tube 120, fastener holes 153 may each be aligned with two fastener holes of each mounting plate 122a, 122b. For example, referring to FIG. 2B, two fastener holes 153 at second end 152b of inlet cap 150 may be aligned with the two fastener holes of mounting plate 122b and two fastener holes 153 at first end 152a of inlet cap 150 may be aligned with the two fastener holes of mounting plate 122a. Next, second bracket 161b may be positioned about inlet cap 150 such that inlet 151 extends through aperture 163b and such that the each fastener hole of mounting plates 165b is aligned with one fastener hole of mounting plates 122a, 122b and one fastener hole 153 of inlet cap 150. A fastener may be inserted through the aligned fastener holes and tightened. For example, when fastened, fastener holes 153 of respective first end 152a and second end 152b may be aligned with fastener holes of one of mounting plates 122a, 122b and fastener holes of one of mounting plates 165b. A portion of tube 120 may be pinched (e.g., compressed, sandwiched, or otherwise held) between the exterior surface curved surface 152 and the interior surface of second bracket 161b. For example, as shown in FIG. 2B, to fasten inlet cap 150 in the first configuration: (i) curved surface 152 of inlet cap 150 is disposed within tube 120 so that inlet 151 extends through aperture 121, (ii) and fastener holes 153 at first end 152a may be aligned with fastener holes of mounting plate 122a and fastener holes of one of mounting plates 165b; and (iii) fastener holes 153 at second end 152b may be aligned with fastener holes of mounting plate 122b and fastener holes of the other of mounting plates 165b.

According to aspects where inlet cap 150 is exterior to tube 120, when fastened, a portion of first end 152a and a portion of second end 152b may be pinched (e.g., compressed, sandwiched, or otherwise held) between one of mounting plates 122a, 122b and one of mounting plates 165b. For example, as shown in FIG. 2B, to fasten inlet cap 150 in the first configuration, first end 152a may be pinched between mounting plate 122a and one of mounting plates 165b, while second end 152b may be pinched between mounting plate 122b and the other of mounting plates 165b. According to some aspects of the disclosure, each of mounting plates 122a, 122b may be fastenable to one of mounting plates 165b and may define a slot configured to receive a portion of curved surface 152.

As discussed above, end cap 130, outlet cap 140, mounting assembly 160 (e.g., brackets 161a, 161b) and supports 180 may be fastened to tube 120 at a plurality of radial orientations (e.g., radial positions) and inlet cap 150 may be fastened to tube 120 in the first configuration or in the second configuration. For example, as shown in FIG. 2A-2B, inlet 151 is positioned in the first configuration. Relative to tube 120, outlet 133a of drop tube 133 is positioned be at approximately 6 o'clock, supports 180 are positioned at approximately 7 o'clock and 5 o'clock, and aperture 121 of tube 120 may be positioned at approximately 10 o'clock. For example, one support 180 (e.g., a first support 180) may be positioned at approximately 5 o'clock on one channel 166 (e.g., a first channel 166) and another support 180 (e.g., a second support 180) may be positioned at approximately 5 o'clock on another channel (e.g., a second channel 166); and that one support 180 (e.g., a third support 180) may be positioned at approximately 7 o'clock on the first channel 166 and another support 180 (e.g., a fourth support 180) may be positioned at approximately 7 o'clock on the second channel 166. As discussed above, each support 180 may be fastened to first bracket 161a and/or second bracket 161b.

In some aspects, as shown in FIG. 9, assembly 110 may include a second orientation with inlet 151 positioned in the second configuration. Relative to tube 120, outlet 133a of drop tube 133 is positioned approximately at 6 o'clock, supports 180 are positioned at approximately 2 o'clock and 4 o'clock, and aperture 121 of tube 120 is positioned at approximately 9 o'clock. As shown in FIG. 9, for example, one support 180 (e.g., a first support 180) may be positioned at approximately 2 o'clock on one channel 166 (e.g., a first channel 166) and another support 180 (e.g., a second support 180) may be positioned at approximately 2 o'clock on another channel (e.g., a second channel 166); and that one support 180 (e.g., a third support 180) may be positioned at approximately 4 o'clock on the first channel 166 and another support 180 (e.g., a fourth support 180) may be positioned at approximately 4 o'clock on the second channel 166.

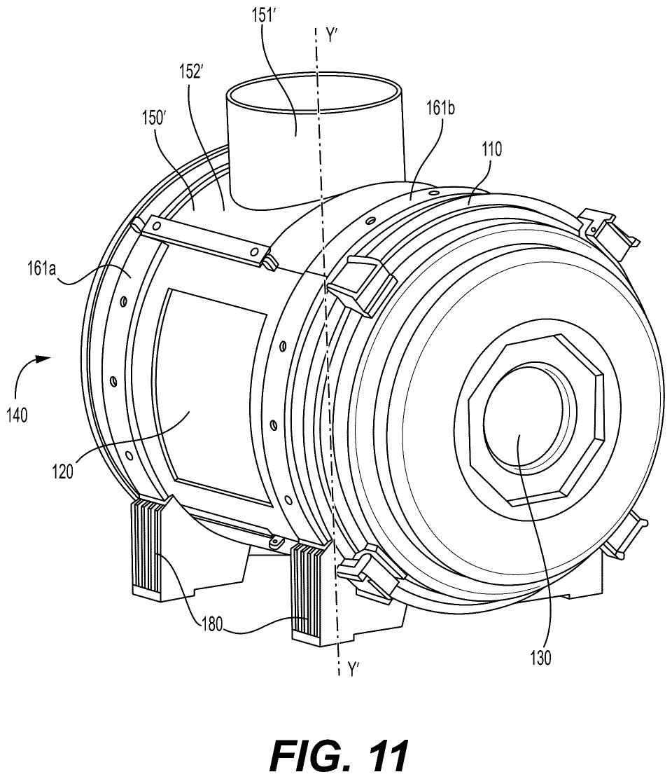

In another example, as shown in FIG. 10, assembly 110 may include a third orientation. Relative to tube 120, inlet 151 is positioned in the second configuration, outlet 133a of drop tube 133 is positioned at approximately 6 o'clock, supports 180 are positioned at approximately 11 o'clock and 1 o'clock, and aperture 121 of tube may be positioned at approximately 3 o'clock. For example, one support 180 (e.g., a first support 180) may be positioned at approximately 1 o'clock on one channel 166 (e.g., a first channel 166) and another support 180 (e.g., a second support 180) may be positioned at approximately 1 o'clock on another channel (e.g., a second channel 166); and that one support 180 (e.g., a third support 180) may be positioned at approximately 11 o'clock on the first channel 166 and another support 180 (e.g., a fourth support 180) may be positioned at approximately 11 o'clock on the second channel 166.

FIG. 11 depicts another example of assembly 110 including a fourth orientation. In the fourth orientations, an opening of inlet 151′ is positioned at approximately 12 o'clock, aperture 121 (not visible in view of FIG. 11) is positioned at approximately 12 o'clock, and supports 180 are positioned at approximately 7 o'clock and 5 o'clock. It should be understood that outlet 133a of end cap 130 has been omitted from FIG. 11, to highlight features of inlet cap 150′. Further, for all orientations, it should be understood that outlet cap 140 and end cap 130 may each be fastened to tube 120 at any radial orientation relative to tube 120. Additionally, outlet cap 140 may be fastened to second end 120a at any radial orientation relative to central axis X such that boss 142 may be pointed in any radial direction relative to central axis X. It should be understood that assembly 110 is not limited to the orientations shown in the Figures, and assembly 110 may be assembled into any orientation permitted by the radial orientations of aperture 121, end cap 130, outlet cap 140, brackets 161a, 161b, and supports 180, and the configuration of inlet 151.

### INDUSTRIAL APPLICABILITY

Assembly 110, as described herein, may be used to clean and/or remove debris from air prior to air inflowing into a combustion engine of machine 100.

Assembly 110 with tube 120 with aperture 121, end cap 130, outlet cap 140, brackets 161a, 161b, and supports 180 may each be fastened, as described above, in a plurality of radial orientations (e.g., radial positions) relative to central axis X. The radial orientations (e.g., relative to central axis X) of one or more of aperture 121, end cap 130, outlet cap 140, brackets 161a, 161b, and supports 180 may be independent from the radial orientations of others of aperture 121, end cap 130, outlet cap 140, brackets 161a, 161b, and supports 180. In addition, as described above, inlet 151 may be arranged in a first configuration (e.g., FIG. 2A) so as to direct air in a counter-clockwise direction and a second configuration (e.g., FIG. 7) so as to direct air in a clockwise direction, or as shown in FIG. 11, inlet 151′ may direct inflowing air directly into filter 114, independent of the orientations of aperture 121, end cap 130, outlet cap 140, brackets 161a, 161b, and supports 180. As such, assembly 110 permits precise and flexible arrangements of components to satisfy a variety of needs and environments. The components of assembly 110 may be assembled and fastened to one another in a plurality of orientations (see e.g., FIGS. 2A, 9, 10, and 11) based on the specifications (e.g., dimensions of engine bay 102 and dimensions of other engine bay components therein) of a machine (e.g., machine 100). Assembly 110 may be transferrable to another, different machine, with specifications different from machine 100, by adjustment of the radial orientation of one or more of aperture 121, end cap 130, outlet cap 140, brackets 161a, 161b, and supports 180 and/or by adjustment of the configuration of inlet 151.

The modularity of assembly 110 may permit the user to easily replace one or more of filter 114, end cap 130, outlet cap 140, inlet cap 150, brackets 161a, 161b, and supports 180 without necessitating replacement of each component of assembly 110. For example, if inlet cap 150 becomes damaged during use, the user may disassemble an entirely or a portion of assembly 110, such as mounting assembly 160, and replace inlet cap 150 with an undamaged inlet cap 150 and then refasten mounting assembly 160 with the undamaged inlet cap 150. In another example, when the user requires a sensor incompatible with boss 142 of outlet cap 140, the user may replace outlet cap 140 with a different outlet cap 140 with an appropriate number of bosses or bosses with appropriate dimensions or features.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A modular filter assembly comprising:
a tube extending along a central axis from a first end to a second end and configured to receive a filter;
an aperture extending through a wall of the tube;
an end cap at the first end of the tube;
an outlet cap at the second end of the tube;
an inlet cap including an inlet extending radially outward from the central axis;
wherein the inlet cap is configured to be fastened to the aperture in a first configuration and a second configuration, different than the first configuration, and wherein the inlet is in communication with the aperture in each of the first configuration and the second configuration.

2. The assembly of claim 1, wherein in the first configuration, the inlet is positioned such that gas received within the tube circulates in a counter-clockwise direction relative to the central axis, and wherein in the second configuration, the inlet is positioned such that gas received within the tube circulates in a clockwise direction relative to the central axis.

3. The assembly of claim 1, wherein the outlet cap is fastenable to the tube at a plurality of radial orientations relative to the central axis.

4. The assembly of claim 3, wherein the outlet cap is fastenable to a plurality of fastener holes positioned at the second end of the tube.

5. The assembly of claim 4, wherein the plurality of fastener holes are evenly arranged along an inner circumference of the tube.

6. The assembly of claim 3, wherein the first end of the tube includes a flange extending radially outward from the central axis.

7. The assembly of claim 6, wherein the end cap is fastenable to the flange.

8. The assembly of claim 1, wherein the inlet cap includes a curved surface, and the wall of the tube includes a curved surface.

9. The assembly of claim 8, wherein a radius of an arc of the curved surface of the inlet cap is approximately less than or equal to a radius of an arc of the curved surface of the tube.

10. The assembly of claim 8, wherein the curved surface of the inlet cap is configured to at least partially cover the aperture of the tube.

11. The assembly of claim 1 further comprising two or more brackets, wherein the two or more brackets radially surround an exterior surface of the tube.

12. The assembly of claim 11, wherein each of the two or more brackets includes a curved surface, and wherein a radius of an arc of the curved surface of the brackets is approximately greater than or equal to a radius of an arc of the curved surface of the tube.

13. The assembly of claim 12, wherein one of the two or more brackets is an inlet bracket; wherein the inlet bracket includes an opening sized and shaped to receive the inlet of the inlet cap.

14. The assembly of claim 13, wherein the curved surface of the inlet cap is fastened to an interior surface of the tube.

15. The assembly of claim 11, wherein each of the two or more brackets include one or more fastener holes at a first side and include one or more fastener holes at a second side, opposite to the first side.

16. A modular filter assembly comprising:
a tube extending along a central axis between a first end and a second end, the tube including an aperture extending through a surface of the tube;
an end cap at the first end of the tube;
an outlet at the second end of the tube;
an inlet extending radially outward from the surface of the tube along an axis orthogonal to the central axis;
wherein the inlet is configured to be fastened to the aperture in a first configuration and a second configuration, different than the first configuration, and wherein the inlet is in communication with the aperture in each of the first configuration and the second configuration;
wherein the outlet is fastenable to the second end of the tube at a plurality of radial orientations relative to the central axis.

17. The assembly of claim 16, wherein in the first configuration, the inlet is positioned such that gas received within the tube circulates in a counter-clockwise direction relative to the central axis, and wherein in the second configuration, the inlet is positioned such that gas received within the tube circulates in a clockwise direction relative to the central axis.

18. The assembly of claim 17, wherein the end cap is fastenable to the tube at a plurality of radial orientations relative to the central axis.

19. The assembly of claim 18, wherein the outlet includes one or more bosses extending radially outward from the central axis configured to receive one or more sensors.

20. A modular filter assembly comprising:
a tube defining a chamber and extending along a central axis;
an aperture extending through a wall of the tube;
an end cap;
an outlet;
an inlet extending radially outward from the central axis;
wherein the inlet is in communication with the chamber via the aperture;
wherein the inlet is configured to be fastened to the aperture in a first configuration and a second configuration, different than the first configuration;
wherein in the first configuration, the inlet is positioned such that gas received within the tube circulates in a counter-clockwise direction relative to the central axis, and wherein in the second configuration, the inlet is positioned such that gas received within the tube circulates in a clockwise direction relative to the central axis;
wherein the outlet is fastenable to the tube at a plurality of radial orientations relative to the central axis;
wherein the end cap is fastenable to the tube at a plurality of radial orientations relative to the central axis.
